(19) United States
(12) Patent Application Publication
(10) Pub. No.: US 2025/0113861 A1
(43) Pub. Date: Apr. 10, 2025

(54) AEROSOL-GENERATING DEVICE WITH MULTIPLE-TAB BATTERY

(71) Applicant: Philip Morris Products S.A., Neuchatel (CH)

(72) Inventors: Yiu Chi CHEUNG, Hong Kong (HK); Guoqiang CAI, Shenzhen (CN)

(73) Assignee: Philip Morris Products S.A., Neuchatel (CH)

(21) Appl. No.: 18/729,270

(22) PCT Filed: Jan. 25, 2022
(86) PCT No.: PCT/CN2022/073750

§ 371 Date: Jul. 16, 2024

(51) Int. Cl. A24F 40/40; A24F 40/53; H01M 50/538

(52) U.S. Cl. CPC A24F 40/40; A24F 40/53; H01M 50/538; H01M 2220/30

(57) ABSTRACT

An aerosol-generating device is provided, including: a battery configured to supply power for heating, the battery including a cathode-anode, the cathode-anode including a cathode and an anode, the cathode and the anode being wound around a longitudinal direction to form a plurality of windings, at least one of the cathode and the anode being provided with at least two tabs, the at least two tabs being arranged in a distance from each other, and a number of the at least two tabs being less than a number of the windings. A method of operating an aerosol-generating device is also provided.

The present invention relates to an aerosol-generating device with a battery to supply power for heating. The present invention also relates to a method for operating an aerosol-generating device and a use of an aerosol-generating device with increased rate capability of a battery.

Known handheld electrically operated smoking systems typically comprise an aerosol-generating device comprising a battery, control electronics and an electric heating element for heating an aerosol-generating article designed specifically for use with the aerosol-generating device. In some examples, the aerosol-generating article comprises an aerosol-forming substrate, such as a tobacco rod or a tobacco plug, and the heating element contained within the aerosol-generating device is inserted into or located around the aerosol-forming substrate when the aerosol-generating article is inserted into the aerosol-generating device. In an alternative electrically operated smoking system, the aerosol-generating article may comprise a capsule containing an aerosol-forming substrate, such as loose tobacco.

In prior art aerosol-generating devices, single-tab batteries are used to enable a compact design. However, the time required for heating up the aerosol-forming substrate is relatively long, since the current flow is limited by the single tab. Increasing the current flow would cause rapid ageing of the battery. As a consequence, either user experience is reduced by slow heating or imprecise temperature control, or the battery life decreases.

It would be preferable to provide an aerosol-generating device with a battery, which is capable of delivering a considerable amount of energy in a short time, while still being small enough to be used in a highly compact aerosol-generating device.

According to a first aspect of the invention, there is provided an aerosol-generating device comprising a battery, wherein the battery is configured to supply power for heating. The battery comprises a cathode-anode unit. The cathode anode-unit comprises a cathode and an anode. At least one of the cathode and anode is provided with at least two tabs. The at least two tabs may be arranged in a distance to each other.

In general, tabs in a battery are provided at the anode or cathode, enabling the flow of electric current to or from the anode or cathode. The tabs may be integrally formed with or directly attached to the anode or cathode. The at least two tabs may enable to deliver a considerable amount of energy in a short time for swiftly heating the heating element to operating temperature. The at least two tabs may enable to swiftly compensate temperature loss, during intermittent aerosol generation. The battery may nevertheless be compact.

The battery may have an energy capacity of in between at least 1600 joule and 2400 joule, in particular in between 1800 joule and 2200 joule. The energy capacity of the battery may be limited to a predefined number of intermittent aerosol-generating operations. In particular, the energy capacity of the battery may be adapted to supply at least 2, preferably 2 to 5, in particular 2 to 3 aerosol-generating cycles per one full charging of the battery. An aerosol-generating cycle corresponds to the consumption of an aerosol-generating article with the aerosol-generating device. Each aerosol-generating cycle may comprise in between at least 5 and not more than a maximum number of 30, preferably in between at least 7 and not more than a maximum number of 20, intermittent aerosol-generating operations, namely puffs of a consumer. The aerosol-generating device may be adapted to allow only a certain number or the aforementioned maximum number of aerosol-generating operations, either by signalling the end of an aerosol-generating cycle to the consumer, or by only supplying power for aerosol-generating operations not exceeding a certain number or the aforementioned maximum number of aerosol-generating operations.

In particular, the distance in between the at least two tabs is the extension of the cathode or the anode in between the at least two tabs. The at least two tabs may be arranged for transferring power from the battery to an electrical circuitry of the aerosol-generating device. The at least two tabs may be arranged for transferring power from an external voltage source to the battery. The at least two tabs may be formed of material with electrically conductive properties, in particular metal or metal alloys, more in particular copper or aluminium.

For generating aerosol, electric power may be drawn from the battery and provided to the heating element via power supply electronics including a controller. The controller may be adapted to supply power to the heating element, only when the temperature of the heating element or aerosol-forming substrate falls below a threshold.

The use of the at least two tabs reduces the travelling distance of electrons in the cathode or anode to reach the tabs. Therefore, battery rate capability is higher compared to a single-tab design. A considerable amount of energy can be generated in a short time with low polarization even at high current loads, as required for the heating discharge pulse.

The main extension direction of the battery, namely the direction in which the battery has its greatest length, may be in a longitudinal direction. A transversal direction may be perpendicular to the longitudinal direction. In an upright orientation of the aerosol-generating device or battery, the longitudinal direction may be a height direction and the transversal direction may be a horizontal direction. The transversal direction may be perpendicular to a width direction of the aerosol-generating device or battery. Any indications in the following regarding “upper”, “top”, “lower” and “bottom” are with respect to the longitudinal direction being the height direction.

The aerosol-generating device may be adapted to be handheld. It may have a longest side length of less than 20 centimeters, of less than 15 centimeters or of less than 10 centimeters. It may have a longest side length of more than 5 centimeters.

The battery may be a lithium iron phosphate (LFP) battery, wherein the cathode of the battery comprises LFP. Additionally or alternatively, the cathode may comprise Nickel-Manganese-Cobalt-Oxide (NMC), Lithium-Cobalt-Oxide (LCO), Nickel-Cobalt-Aluminium-Oxide (NCA), or any combination thereof.

The tabs may be provided at an edge of the cathode. All tabs may be provided at the same edge of the cathode.

In particular, the cathode-anode unit further comprises a separator. The separator is provided in between the cathode and the anode. The separator may comprise a polymer.

The battery may comprise a cap. The cap may provide a terminal for an electrical circuitry of the aerosol-generating device. The cap may have a cap end wall and a cap side wall. The cap may be electrically connected to the tabs of the cathode or the anode.

The battery may comprise a shell. The shell may provide a cavity for the cathode-anode unit. The cathode-anode unit may be fully arranged in the shell. The shell may provide a terminal for the electrical circuitry of the aerosol-generating device.

The shell may comprise a shell side wall and a shell end wall. The shell end wall may be electrically connected to the shell side wall. The shell side wall may have a larger surface than the cap side wall. The shell side wall may have a cylindrical shape.

The cap may be isolated from the shell.

The shell may be electrically connected to the anode.

The at least two tabs of the cathode may be attached to the cap. The cap may be electrically connected to the cathode.

The at least two tabs of the anode may be attached to the shell.

In particular, the battery has a housing. In particular, the housing comprises the shell and the cap for closing the shell.

The at least two tabs may be folded and attached, in particular welded or soldered, to the cap.

The at least two tabs or more than two tabs may form a stack of overlapping tabs. The stack may be formed of the overlapping tabs as layers. The stack may be stacked in the longitudinal direction.

Preferably, the battery may be a jellyroll battery. The cathode and the anode of the cathode-anode unit may be provided to form a jellyroll having a plurality of windings. The cathode and the anode may be wound around a longitudinal direction to form the jellyroll. Alternatively, the cathode and the anode of the cathode-anode unit may form a pouch cell.

The cathode and the anode may be wound around a longitudinal direction to form a plurality of windings. Optionally, at least one of the cathode and anode may be provided with a number of tabs less than the number of windings. This may reduce the height of the stack compared to batteries having a tab in each winding and enable more space for the cathode and anode. This may increase the energy capacity and the volumetric energy density of the battery.

The plurality of windings may have a height of in between 11 millimeters and 110 millimeters, preferably in between 25 millimeters to 45 millimeters, in particular in between 37 millimeters to 39 millimeters.

The plurality of windings may have a diameter of 5 millimeters to 20 millimeters, in particular in between 8 millimeters to 13 millimeters, in particular less than 10.5 millimeters.

The plurality of windings may have a cylindrical shape.

The plurality of windings may have a prismatic shape. This may increase the outer surface of the plurality of windings and thus reduces heat generation within the battery.

The battery may comprise carbonate-based electrolytes.

The cathode-anode unit or battery may have a height of in between 11 millimeters and 110 millimeters, preferably in between 25 millimeters to 45 millimeters, in particular in between 37 millimeters to 39 millimeters.

The cathode-anode unit or battery may have a diameter of 5 millimeters to 20 millimeters, in particular in between 8 millimeters to 13 millimeters, in particular less than 10.5 millimeters.

The at least one of the cathode and anode may be provided with only one tab per at least 2, at least 5, or at least 15 windings. The at least one of the cathode and anode may be provided with at least one tab per 30, 25, or 15 windings.

At least one of the cathode and anode may be provided with at least three tabs.

At least one of the cathode and anode may be provided with two to eight tabs, in particular with two to five tabs, more in particular two to four tabs.

At least two or three tabs may be provided on the cathode.

Both the cathode and the anode may be provided with at least two or three tabs. Alternatively, both the cathode and the anode may be provided with four tabs.

The tabs of the cathode and the tabs of the anode may be provided on opposite sides of the battery. The tabs of the cathode and the tabs of the anode may extend from the opposite longitudinal end faces of the cathode-anode unit.

In case exactly two tabs are provided on one or each of the cathode and anode, the distance between the tabs of the anode may be between 330 millimeters to 480 millimeters, preferably between 380 millimeters to 480 millimeters, particularly between 430 millimeters to 480 millimeters. The distance between the tabs of the cathode may be between 200 millimeters to 400 millimeters, preferably between 250 millimeters to 350 millimeters, particularly between 280 millimeters to 320 millimeters. Preferably, the two tabs may be located at opposite ends of one edge of the anode or cathode, in particular at two horizontal ends of the anode or cathode.

In case exactly three tabs are provided on one or each of the cathode and anode, the distance between the tabs of the anode may be between 165 millimeters to 240 millimeters, preferably between 190 millimeters to 240 millimeters, particularly between 215 millimeters to 240 millimeters. The distance between the tabs of the cathode may be between 100 millimeters to 200 millimeters, preferably 125 millimeters to 175 millimeters, particularly between 140 millimeters to 160 millimeters. Preferably, two of the three tabs are located at opposite ends of one edge of the anode or cathode, and one tabs is located in between the two tabs on the same edge. In particular, the tabs are located at two horizontal ends and in the middle of the anode or cathode.

In case exactly four tabs are provided on one or each of cathode and anode, the distance between the tabs of the anode may be between 110 millimeters to 160 millimeters, preferably between 125 millimeters to 160 millimeters, particularly between 143 millimeters to 160 millimeters. The distance between the tabs of the cathode may be between 65 millimeters to 130 millimeters, preferably 85 millimeters to 115 millimeters, particularly between 92 millimeters to 107 millimeters.

In case more than two tabs are provided on one of the anode or cathode, two tabs are located at opposite ends of one edge of the anode or cathode, and the further tabs are located in between the two tabs on the same edge.

The width of the tabs may be between 1 millimeter to 5 millimeters, preferably between 2 millimeters to 4 millimeters, particularly between 3 millimeters to 4 millimeters.

In particular, the cathode comprises a cathode current collector and a cathode active material. In particular, the anode comprises an anode current collector and an anode active material.

The cathode may be formed of multilayer sheet material, comprising a cathode current collector layer and a cathode active material layer. The cathode active material layer may be a coating on one side of the cathode current collector. The coating forming the cathode active material layer may have a thickness of 30 micrometers to 60 micrometers, preferably of 40 micrometers to 50 micrometers. This thickness range may prevent cycle life to decrease while supporting high discharge currents above 1, 2 or 3 ampere during heating. This thickness range may provide energy to support two consecutive aerosol-generating cycles each comprising in between 7 to 18 puffs of a consumer. An aerosol-generating cycle may require energy from the battery of at least 700 joule and less than 1500 joule, in particular of at least 900 joule, more in particular of about 1000 joule.

The anode may be formed of multilayer sheet material, comprising an anode current collector layer and an anode active material layer. The anode active material layer may be a coating on one side of the anode current collector. The coating forming the anode active material layer may have a thickness of 20 micrometers to 50 micrometers, preferably of 25 micrometers to 40 micrometers. This thickness range may prevent cycle life to decrease while supporting charging rates from 1 ampere to 2 ampere, preferably around 1.6 ampere. This thickness range may support consistent and equal coating.

At least one of the anode and cathode may include a conductive area and a non-conductive area extending in a horizontal direction of the multilayer sheet material. The horizontal direction may correspond to a main extension direction of the multilayer sheet material, namely the direction in which the multilayer sheet material has its greatest length in an unrolled state.

The conductive area may comprise an area with active material and an area without active material. The non-conductive area may be provided with adhesive tape for holding the cathode-anode unit in place.

The conductive area of the anode may have a length of between 350 millimeters to 500 millimeters, preferably of between 400 millimeters to 500 millimeters, particularly of between 450 millimeters to 500 millimeters. The conductive area of the anode may have a width of between 25 millimeters to 40 millimeters, preferably of between 30 millimeters to 40 millimeters, particularly of between 30 millimeters to 35 millimeters.

The conductive area of the cathode may have a length of between 350 millimeters to 450 millimeters, preferably of between 375 millimeters to 450 millimeters, particularly of between 400 millimeters to 450 millimeters. The conductive area of the cathode may have a width of between 25 millimeters to 40 millimeters, preferably of between 30 millimeters to 40 millimeters, particularly of between 30 millimeters to 35 millimeters.

The at least two tabs may be integrally formed by the cathode current collector. The at least two tabs may be integrally formed by the anode current collector. The at least two tabs may be integrally formed by at least one of the cathode current collector and the anode current collector. This may reduce the electrical resistance between the tabs and the current collector. The at least one of the cathode current collector and anode current collector may be formed by cutting.

The cathode active material layer may comprise lithium iron phosphate, LiFePO4 (LFP). Alternatively, the cathode active material layer may comprise nickel manganese cobalt oxides (NCM). The use of LFP cathodes may increase cycle stability of the battery and thus lifetime of the aerosol-generating device, particularly in contrast to NCM batteries. LFP cathodes may have a small conductivity compared to other cathode materials such as NCM. Thus, applying at least two tabs on a LFP cathode may increase the battery rate capability even more than applying at least two tabs on an NCM cathode.

The anode active material layer may comprise graphite, silicon and/or lithium-titanate-oxide (LTO).

At least one of the at least two tabs may be attached to the cathode current collector, in particular ultrasonically or resistively welded.

At least one of the at least two tabs may be attached to the anode current collector, in particular ultrasonically or resistively welded. The at least one tab attached to the anode current collector may be made of nickel. The attached at least one tab attached to the cathode current collector may be made of aluminum.

The tabs may have a rectangular, trapezoidal or needle shape. This may reduce the height of a stack of tabs compared to the height of the stack of tabs having rectangular-shape. More space for the cathode-anode unit may remain. This may increase the energy capacity and the volumetric energy density of the battery. Tabs with a needle-shape may have an increased mechanical strength. Thus, the durability of the tabs for folding may be increased.

The tabs may be extending from the cathode or the anode towards the periphery of the battery. This may reduce the height of the stack compared to the height of the stack of batteries having tabs folded towards the center of the battery and enable more space for the cathode-anode unit. This may increase the energy capacity and the volumetric energy density of the battery.

The tabs may be extending from the cathode or the anode towards the center of the battery.

The tabs may be trapezoidal-shaped and folded inwardly.

The tabs may be trapezoidal-shaped or rectangular-shaped and folded outwardly.

The tabs may be needle-shaped and folded outwardly or inwardly.

Preferably, the tabs may be needle-shaped. This needle-shape increases the mechanical strength of the tabs. Thus, the likelihood of broken tabs can be reduced, particularly during folding.

Preferably, the tabs of the cathode may be at least one of: rectangular-shaped and folded outwardly away from a center of the battery, trapezoidal-shaped and folded inwardly towards a center of the battery, trapezoidal-shaped and folded outwardly away from a center of the battery, needle-shaped and folded inwardly towards a center of the battery, or needle-shaped and folded outwardly away from a center of the battery.

Alternatively or additionally, the tabs of the anode may be at least one of: rectangular-shaped and folded inwardly towards a center of the battery, or trapezoidal-shaped and folded inwardly towards a center of the battery.

The battery may be provided with an electrically conductive structure having connection ports for the tabs. The electrically conductive structure enables to facilitate the connections for the tabs to a terminal of the battery. In particular, this facilitates the assembly of comparably small batteries. The electrically conductive structure may allow the tabs to be attached to the connection ports instead of the cap. This may prevent that a stack of tabs is formed and enable more space for the cathode-anode unit. This may increase the energy capacity and the volumetric energy density of the battery. Attaching the tabs to the electrically conductive structure may also reduce the number and angle of folds in the tabs. Thus, the risk that the tabs may break during folding may be reduced.

The electrically conductive structure may bridge a distance in a longitudinal direction in between the cathode or the anode and a terminal of the battery. The electrically conductive structure may have a longitudinal extension of 2 millimeters to 8 millimeters.

The terminal may be provided on a cap of the battery that is electrically isolated from a shell of the battery.

The electrically conductive structure may electrically connect the tabs in parallel. The electrically conductive structure may connect the tabs of the cathode.

Attaching the tabs to the connection ports may comprise soldering or welding.

The electrically conductive structure may comprise a non-conductive structure for isolating the tabs from a terminal of the battery. The terminal may provide an electric potential different from the electric potential of the tabs.

The electrically conductive structure may be attached on a longitudinal end face of the cathode-anode unit. Preferably, the electrically conductive structure may be sealed to the shell, such that the battery is fixed via its longitudinal end face. Prior art batteries have a neck portion for holding the cathode-anode unit in position. Attaching the electrically conductive structure on the longitudinal end face of the cathode-anode unit may overcome the requirement for such a neck portion. This allows more space for the cathode-anode unit. This may increase the energy capacity and the volumetric energy density of the battery.

The connection ports of the electrically conductive structure may be openings for receiving the tabs. The openings may be provided as holes or slots.

The size and shape of the openings may correspond to the size and shape of the tabs. Holes may be provided when needle-shaped tabs are used. Slots may be provided when trapezoidal-shaped or rectangular-shaped tabs are used.

The tabs of the cathode may be provided at the electrically conductive structure at least one of: rectangular-shaped and folded outwardly away from a center of the battery, trapezoidal-shaped and folded inwardly towards a center of the battery, trapezoidal-shaped and folded outwardly away from a center of the battery, needle-shaped and folded inwardly towards a center of the battery, or needle-shaped and folded outwardly away from a center of the battery.

Alternatively or additionally, the tabs of the anode may be provided at the electrically conductive structure at least one of: rectangular-shaped and folded inwardly towards a center of the battery, or trapezoidal-shaped and folded inwardly towards a center of the battery.

The aerosol-generating device may further comprise an aerosol-generating means, in particular a heating element. The aerosol-generating means or heating element may be electrically connected to the battery.

The heating element may be an induction coil.

The heating element may be an electrical resistance heating means.

The aerosol-generating device may further comprise power supply electronics. The power supply electronics may be adapted to supply power from the battery for heating. The power supply electronics may be an electrical circuitry of the aerosol-generating device. The power supply electronics may control the power that is supplied to the heating element.

The power supply electronics may comprise a power converter. The power converter may be electrically connected to the terminals of the battery.

The power converter may comprise a DC/AC inverter or a DC/DC converter.

The aerosol-generating device may further comprise a sensor for obtaining a heating temperature. The heating temperature may be indicative of a temperature of the heating element or of the aerosol-forming substrate.

The aerosol-generating device may further comprise a control device adapted to control the power supply electronics for supplying power from the battery for heating. The control device may comprise a controller in form of a microcontroller, a field programmable gate array (FPGA) or application-specific integrated circuit (ASIC).

The control device may be operatively coupled to the sensor for obtaining the heating temperature and the power converter in a feedback-loop configuration.

The controller may be configured to receive a feedback signal from the sensor indicative of the heating temperature and control the power converter in response to the received feedback signal to draw power from the battery.

The control device may comprise a bang-bang controller. In particular, the bang-bang controller is adapted to switch on when the feedback signal is below a lower threshold value, and to switch off when a feedback signal is above a higher threshold value. The control device may form part of the power supply electronics.

The aerosol-generating device may further comprise an aerosol-generating article receiving means. The aerosol-generating article receiving means is adapted to receive an aerosol-generating article. The aerosol-generating article receiving means may be a cavity.

According to a second aspect of the invention, there may be provided an aerosol-generating system comprising the aerosol-generating device according to the first aspect of the invention.

The aerosol-generating system may also comprise an aerosol-generating article.

The aerosol-generating article may comprise a susceptor.

The aerosol-generating article may comprise an aerosol-generating substrate.

The aerosol-generating substrate may be made of aerosol-generating sheet-material.

The aerosol-generating sheet-material may be crimped, folded or cut.

The susceptor may be embedded in the aerosol-generating substrate.

According to a third aspect of the invention, there may be provided a method of manufacturing a battery for an aerosol-generating device. The method may comprise the step of providing a cathode-anode unit comprising one or more tabs at a longitudinal end face of the cathode-anode unit. The method may also comprise the step of arranging an electrically conductive structure on the longitudinal end face of the cathode-anode unit, such that the one or more tabs are in contact with one or more connection ports of the electrically conductive structure.

The cathode-anode unit may be provided to comprise at least two tabs at the longitudinal end face.

The step of providing the cathode-anode unit may comprise the step of cutting a cathode or anode current collector layer to provide the one or more tabs. The step of providing the cathode-anode unit may further comprise the step of winding the cathode-anode unit having the cut cathode or anode current collector around a longitudinal axis to form a jellyroll.

The electrically conductive structure may be arranged on the longitudinal end face of the cathode-anode unit, such that the electrically conductive structure is fully arranged inside the battery.

The step of arranging the electrically conductive structure may comprise the step of passing the one or more tabs through one or more associated openings forming the one or more ports of the electrically conductive structure.

The step of arranging the electrically conductive structure may comprise the step of attaching the electrically conductive structure to the shell. The electrically conductive structure may be sealed to the shell.

Preferably, needle-shaped tabs may be provided and passed through the openings. The mechanical strength of the needle-shaped tabs may allow the tabs to easily pass through the openings.

The method may further comprise the step of arranging the cathode-anode unit and the electrically conductive structure in the shell. The method may further comprise the step of closing the shell with a cap. The cap may be electrically connected to the one or more tabs via the electrically conductive structure, and may be electrically isolated from the shell.

The step of closing the cap may further comprise attaching the electrically conductive structure to the cap, in particular by soldering, ultrasonically or resistively welding.

The step of arranging the electrically conductive structure may comprise the step of folding the one or more tabs towards the electrically conductive structure. The step of arranging the electrically conductive structure further comprise attaching the one or more tabs at the electrically conductive structure, in particular by soldering, ultrasonic or resistive welding.

According to a fourth aspect of the invention, there may be provided an aerosol-generating device comprising a battery. The battery may be configured to supply power for heating. The battery comprises a cathode-anode unit, wherein the cathode-anode unit may be provided with one or more tabs at the longitudinal end face of the cathode-anode unit. The battery may further comprise an electrically conductive structure. The electrically conductive structure may be provided on the longitudinal end face of the cathode-anode unit and may comprise one or more connection ports for the one or more tabs. The one or more connection ports may be in contact with the one or more tabs.

The electrically conductive structure may bridge a distance in a longitudinal direction in between the cathode-anode unit and a terminal of the battery.

The electrically conductive structure may have longitudinal extension of 3 millimeters to 8 millimeters.

The electrically conductive structure may comprise a platform and a connector.

The platform may have a peripheral section, which corresponds to an inner rim of the shell of the battery.

The platform may be arranged on the longitudinal end face of the cathode-anode unit.

The platform may be made of conductive structure and a non-conductive structure.

The conductive structure may comprise the one or more connection ports in form of one or more holes for receiving the one or more tabs. The one or more openings may be provided as holes. In other examples, one or more slots may be provided. The size and shape of the one or more openings may complement to the size and shape of the one or more tabs. The conductive structure of the platform may be made of one or more of iron, copper, aluminium, nickel; most preferably nickel.

The non-conductive structure may be formed in a peripheral section of the conductive structure, such that the conductive structure is electrically isolated from the shell. The platform may be attached to the shell, such that the cathode-anode unit is fixed to a longitudinally position with respect to the shell.

The thickness of the platform may be between 0.05 millimeters and 0.5 millimeters, preferably between 0.1 millimeters and 0.2 millimeters.

In between the platform and the cap of the battery, a connector may be provided. The connector may bridge a distance in the longitudinal direction in between the cathode-anode unit and the cap.

The connector may comprise a conductive structure to electrically connect the tabs to the cap and a non-conductive structure for isolating the conductive material from the shell.

The conductive structure of the connector may have three connector sections, wherein at least one of a first connector section and a second connector section may be connected to a third connector section at an angle of between 60 to 120 degrees, preferably of between 80 to 100 degrees. The first connector section and the second connector section may extend in the same transversal direction.

The first connector section may be attached to the cap. The second connector section may be attached to the conductive structure of the platform. The conductive structure of the connector may be made of one or more of iron, copper, aluminium, nickel, most preferably aluminium or nickel.

In the following, examples on tab designs are provided in case the tabs are attached to the electrically conductive structure:

The tab extending the height may be between 1 millimeter to 5 millimeters, preferably between 2 millimeters to 4 millimeters. The tab extending the height may correspond to a length of a portion of the one or more tabs that extend from the anode or cathode current collector layer in the height direction.

In case one or more rectangular-shaped tabs are provided, the tab width may be between 1 millimeter to 5 millimeters, preferably between 2 millimeters to 4 millimeters, particularly between 3 millimeters to 4 millimeters. The thickness of the one or more rectangular-shaped tabs may be around 0.1 millimeters.

In case one or more trapezoidal-shaped tabs are provided, the tab width on the current collector side may be between 1 millimeter to 5 millimeters, preferably between 2 millimeters to 4 millimeters, particularly between 3 millimeters to 4 millimeters. The tab width on the distal side may be between 1 millimeter to 4.5 millimeters, preferably 1 millimeter to 3.5 millimeters, particularly between 1 millimeter to 2.5 millimeters. The thickness of the one or more trapezoidal-shaped tabs may be around 0.1 millimeters. The distal side may correspond to the side of the tab with the greatest distance to the current collector in the height direction.

In case one or more needle-shaped tabs are provided, the diameter of the one or more tabs may be between 0.5 millimeters to 3 millimeters, preferably between 0.5 millimeters to 2 millimeters, particularly between 0.5 millimeters to 1 millimeter.

According to a fifth aspect of the invention, there is provided a method of operating an aerosol-generating device, comprising the step of detecting whether aerosol-delivery is requested by a consumer, and delivering power from a battery to an aerosol-generating means via at least two tabs in the battery, wherein the tabs are arranged in parallel in an electrical circuit of which the battery forms part.

The at least two tabs may be connected to or provided at a cathode of the battery. The at least two tabs may be connected to or provided at an anode of the battery. At least two tabs may be connected to or provided at both the cathode and the anode.

The step of detecting whether an aerosol-delivery is requested by a consumer may comprise detecting whether the consumer applies pressure lower than ambient pressure on a mouthpiece of the aerosol-generating device.

The step of delivering power from a battery to an aerosol-generating means via at least two tabs in the battery may comprise drawing discharge current from the battery only when a heating temperature drops below a threshold level. In particular, the threshold level is preset, preferably stored in a memory of the aerosol-generating device.

The discharge current drawn may be a pulsing current comprising at least one on-cycle and at least one off-cycle.

At least one of the on-cycle and off-cycle may have a duration of between 0.5 seconds and 4 seconds, preferably of between 0.75 seconds and 2 seconds, in particular of about 1 second.

At least one of the on-cycle and off-cycle may have a duration of between 0.01 seconds and 3 seconds, preferably of between 0.1 seconds and 2 seconds, in particular of about 0.3 seconds. Preferably, the on-cycle and the off-cycle may have substantially the same duration.

The discharge current may have a peak current of in between 2 ampere and 5 ampere, preferably of between 2.5 ampere and 4 ampere, in particular of about 3.15 ampere.

The method may be carried out at least in part by the control device of the aerosol-generating device.

According to a sixth aspect of the invention, there is provided a use of at least two tabs provided on a cathode or an anode in an aerosol-generating device to increase rate capability of a battery for intermittent heating.

The power may be only drawn from of the battery when a temperature of the heating element drops below a threshold level.

The aerosol-generating device according to the first or fourth aspect of the invention and the system according to the second aspect of the invention may be operated according to the method of the fifth aspect of the invention.

The aerosol-generating device according to the first or fourth aspect of the invention and the system according to the second aspect of the invention may be manufactured according to the method of the third aspect of the invention.

The invention is defined in the claims. However, below there is provided a non-exhaustive list of non-limiting examples and embodiments. Any one or more of the features of these examples may be combined with any one or more features of another example, embodiment, or aspect described herein.

Example Ex1: An aerosol-generating device comprising a battery, wherein the battery is configured to supply power for heating, wherein the battery comprises a cathode-anode unit, wherein the cathode-anode unit comprises a cathode and an anode, wherein at least one of the cathode and anode is provided with at least two tabs, wherein the at least two tabs are arranged in a distance to each other.

Example Ex2: The aerosol-generating device according to Ex1, wherein the battery has an energy capacity of in between at least 1600 joule and 2400 joule, in particular in between 1800 joule and 2200 joule.

Example Ex3: The aerosol-generating device according to any one of examples Ex1 to Ex2, wherein the aerosol-generating device is adapted to be handheld.

Example Ex4: The aerosol-generating device according to any one of examples Ex1 to Ex3, wherein the battery is a lithium iron phosphate battery.

Example Ex5: The aerosol-generating device according to any one of examples Ex1 to Ex4, wherein the tabs are provided at an edge of the cathode.

Example Ex6: The aerosol-generating device according to any one of examples Ex1 to Ex5, wherein the battery further comprises a separator, wherein the separator is provided in between the cathode and the anode.

Example Ex7: The aerosol-generating device according to any one of examples Ex1 to Ex6, wherein the battery comprises a cap, wherein the cap provides a terminal for an electrical circuitry of the aerosol-generating device.

Example Ex8: The aerosol-generating device according to example Ex7, wherein the cap is electrically connected to the tabs of the cathode or the anode.

Example Ex9: The aerosol-generating device according to any one of examples Ex7 to Ex8, wherein the battery further comprises a shell, wherein the shell provides a cavity for the cathode-anode unit, wherein the shell provides a terminal for an electrical circuitry of the aerosol-generating device.

Example Ex10: The aerosol-generating device according to example Ex9, wherein the shell comprises a shell side wall and a shell end wall, wherein the shell end wall is electrically connected to the shell side wall.

Example Ex11: The aerosol-generating device according to any one of examples Ex9 to Ex10, wherein the cap is electrically isolated from the shell.

Example Ex12: The aerosol-generating device according to any one of examples Ex9 to Ex11, wherein the tabs of the cathode are attached to the cap.

Example Ex13: The aerosol-generating device according to any one of examples Ex9 to Ex12, wherein the tabs of the anode are attached to the shell. Example Ex14: The aerosol-generating device according to any one of examples Ex1 to Ex13, wherein the at least two tabs or more than two tabs form a stack of overlapping tabs.

Example Ex15: The aerosol-generating device according to any one of examples Ex1 to Ex14, wherein the cathode and the anode are wound around a longitudinal direction to form a plurality of windings, wherein the number of tabs is less than the number of windings.

Example Ex16: The aerosol-generating device according to example Ex15, wherein the plurality of windings has a height of in between 11 millimeters and 110 millimeters, preferably in between 25 millimeters to 45 millimeters, in particular in between 37 millimeters to 39 millimeters.

Example Ex17: The aerosol-generating device according to any one of examples Ex15 to Ex16, wherein the plurality of windings has a diameter of 5 millimeters to 20 millimeters, in particular in between 8 millimeters to 13 millimeters, in particular less than 10.5 millimeters.

Example Ex18: The aerosol-generating device according to any one of examples Ex15 to Ex17, wherein the plurality of windings has a cylindrical shape.

Example Ex19: The aerosol-generating device according to any one of examples Ex15 to Ex17, wherein the plurality of windings has a prismatic shape.

Example Ex20: The aerosol-generating device according to any one of examples Ex1 to Ex19, wherein only one tab is included per at least 2, at least 5, or at least 15 windings.

Example Ex21: The aerosol-generating device according to any one of examples Ex1 to Ex20, wherein at least one of the cathode and anode is provided with at least three tabs.

Example Ex22: The aerosol-generating device according to any one of examples Ex1 to Ex20, wherein the at least two or three tabs are provided on the cathode.

Example Ex23: The aerosol-generating device according to any one of examples Ex1 to Ex20, wherein both the cathode and the anode are provided with at least two or at least three tabs.

Example Ex24: The aerosol-generating device according to any one of examples Ex1 to Ex23, wherein the tabs of the cathode and the tabs of the anode are provided on opposite sides of the battery.

Example Ex25: The aerosol-generating device according to any one of examples Ex1 to E24, wherein the cathode is formed of multilayer sheet material, comprising

a cathode current collector layer and

a cathode active material layer,

wherein the cathode active material layer is a coating on one side of the cathode current collector, wherein the coating forming the cathode active material layer has a thickness of 30micrometers to 60 micrometers, preferably of 40 micrometers to 50 micrometers.

Example Ex26: The aerosol-generating device according to example Ex25, wherein the anode is formed of multilayer sheet material, comprising an anode current collector layer and an anode active material layer, wherein the anode active material layer is a coating on one side of the anode current collector, wherein the coating forming the anode active material layer has a thickness of 20 micrometers to 50 micrometers, preferably of 25 micrometers to 40 micrometers.

Example Ex27: The aerosol-generating device according to any one of examples Ex25 to Ex26, wherein at least one of the at least two tabs is integrally formed by the cathode current collector.

Example Ex28: The aerosol-generating device according to any one of examples Ex26 to Ex27, wherein at least one of the at least two tabs is integrally formed by the anode current collector.

Example Ex29: The aerosol-generating device according to any one of examples Ex25 to Ex28, wherein the cathode active material layer comprises lithium iron phosphate, LiFePO4.

Example Ex30: The aerosol-generating device according to any one of examples Ex25 to Ex29, wherein at least one of the at least two tabs is attached to the cathode current collector, in particular ultrasonically or resistively welded.

Example Ex31: The aerosol-generating device according to any one of examples Ex26 to Ex30, wherein at least one of the at least two tabs is attached to the anode current collector, in particular ultrasonically or resistively welded.

Example Ex32: The aerosol-generating device according to any one of examples Ex1 to Ex31, wherein the tabs have a rectangular, trapezoidal or needle-shaped shape.

Example Ex33: The aerosol-generating device according to any one of examples Ex1 to Ex32, wherein the tabs are extending from the cathode or the anode towards the periphery of the battery.

Example Ex34: The aerosol-generating device according to any one of examples Ex1 to Ex33, wherein the tabs of the cathode are at least one of:

rectangular-shaped and folded outwardly away from a center of the battery,

trapezoidal-shaped and folded inwardly towards a center of the battery,

trapezoidal-shaped and folded outwardly away from a center of the battery,

needle-shaped and folded inwardly towards a center of the battery, or

needle-shaped and folded outwardly away from a center of the battery.

Example Ex35: The aerosol-generating device according to any one of examples Ex1 to Ex34, wherein the tabs of the anode are at least one of:

rectangular-shaped and folded inwardly towards a center of the battery, or

trapezoidal-shaped and folded inwardly towards a center of the battery.

Example Ex36: The aerosol-generating device according to any one of examples Ex1 to Ex35, wherein the battery further comprises an electrically conductive structure having connection ports for the tabs.

Example Ex37: The aerosol-generating device according to example Ex36, wherein the electrically conductive structure bridges a distance in a longitudinal direction in between the cathode or the anode and a terminal of the battery.

Example Ex38: The aerosol-generating device according to any one of examples Ex36 to Ex37, wherein the terminal is provided on a cap of the battery, wherein the cap is electrically isolated from a shell of the battery.

Example Ex39: The aerosol-generating device according to any one of examples Ex36 to Ex38, Wherein the electrically conductive structure comprises a non-conductive structure for isolating the tabs from a terminal of the battery, wherein the terminal provides an electric potential different from the electric potential of the tabs.

Example Ex40: The aerosol-generating device according to any one of examples Ex36 to Ex39, wherein the electrically conductive structure electrically connects the tabs in parallel.

Example Ex41: The aerosol-generating device according to any one of examples Ex36 to Ex40, wherein the connection ports of the electrically conductive structure are openings for receiving the tabs, in particular holes or slots.

Example Ex42: The aerosol-generating device according to any one of examples Ex1 to Ex41, Further comprising an aerosol-generating means, in particular a heating element, wherein the aerosol-generating means is electrically connectable to the battery.

Example Ex43: The aerosol-generating device according to examples Ex42, wherein the heating element is an induction coil.

Example Ex44: The aerosol-generating device according to example Ex42, wherein the heating element is an electrical resistance heating means.

Example Ex45: The aerosol-generating device according to any one of examples Ex1 to Ex44, further comprising power supply electronics, wherein the power supply electronics is adapted to supply power from the battery for heating.

Example Ex46: The aerosol-generating device according to example Ex45, wherein the power supply electronics comprises a power converter electrically connected to terminals of the battery.

Example Ex47: The aerosol-generating device according to example Ex46, wherein the power converter comprises a DC/AC inverter or a DC/DC converter.

Example Ex48: The aerosol-generating device according to any one of examples Ex1 to Ex47, further comprising a control device, wherein the control device is adapted to control power supply electronics for supplying power from the battery for heating.

Example Ex49: The aerosol-generating device according to any one of examples Ex1 to Ex48, further comprising a sensor for obtaining a heating temperature, wherein the heating temperature is indicative of a temperature of a heating element.

Example Ex50: The aerosol-generating device according to any one of examples Ex1 to Ex49, further comprising an aerosol-generating article receiving means, wherein the aerosol-generating article receiving means is adapted to receive an aerosol-generating article.

Example Ex51: The aerosol-generating device according to example Ex50, wherein the aerosol-generating article receiving means is a cavity.

Example Ex52: An aerosol-generating system comprising the aerosol-generating device according to any one of examples Ex1 to Ex51, and an aerosol-generating article.

Example Ex53: The aerosol-generating system according to example Ex52, wherein the aerosol-generating article comprises a susceptor.

Example Ex54: The aerosol-generating system according to any one of examples Ex52 to Ex53, wherein the aerosol-generating article comprises an aerosol-generating substrate.

Example Ex55: The aerosol-generating system according to example Ex54, wherein the aerosol-generating substrate is made of aerosol-generating sheet-material.

Example Ex56: The aerosol-generating system according to example Ex55, wherein the aerosol-generating sheet-material is crimped, folded or cut.

Example Ex57: The aerosol-generating system according to example Ex53, wherein the susceptor is embedded in the aerosol-generating substrate.

Example Ex58: A method of manufacturing a battery for an aerosol-generating device, comprising the steps of:

providing a cathode-anode unit comprising one or more tabs at a longitudinal end face of the cathode-anode unit, and

arranging an electrically conductive structure on the longitudinal end face of the cathode-anode unit, such that the one or more tabs are in contact with one or more connection ports of the electrically conductive structure.

Example Ex59: The method according to example Ex58, wherein the cathode-anode unit is provided to comprise at least two tabs at the longitudinal end face.

Example Ex60: The method according to any one of examples Ex58 to Ex59, wherein the step of providing a cathode-anode unit comprises the steps of:

cutting a cathode or anode current collector layer to provide the one or more tabs, and

winding the cathode-anode unit having the cut cathode or anode current collector around a longitudinal axis to form a jellyroll.

Example Ex61: The method according to any one of examples Ex58 to Ex60, wherein the electrically conductive structure is arranged on the longitudinal end face of the cathode-anode unit, such that the electrically conductive structure is fully arranged inside the battery.

Example Ex62: The method according to any one of examples Ex58 to Ex61, wherein the step of arranging the electrically conductive structure, comprises the step of passing the one or more tabs through one or more associated openings forming the one or more ports of the electrically conductive structure.

Example Ex63: The method according to any one of examples Ex58 to Ex62, further comprising the steps of:

arranging the cathode-anode unit and the electrically conductive structure in a shell,

closing the shell with a cap,

wherein the cap is electrically connected to the one or more tabs via the electrically conductive structure, and electrically isolated from the shell.

Example Ex64: The method according to example Ex63, wherein the step of closing the cap further comprises attaching the electrically conductive structure to the cap, in particular by soldering, ultrasonic or resistive welding.

Example Ex65: The method according to any one of examples Ex58 to Ex64, wherein the step of arranging the electrically conductive structure, comprises the steps of:

folding the one or more tabs towards the electrically conductive structure, and

attaching the one or more tabs at the electrically conductive structure, in particular by soldering, ultrasonically or resistively welding.

Example Ex66: An aerosol-generating device comprising

a battery,

wherein the battery is configured to supply power for heating,

wherein the battery comprises

a cathode-anode unit,

wherein the cathode-anode unit is provided with one or more tabs at a longitudinal end face of the cathode-anode unit, and

an electrically conductive structure,

wherein the electrically conductive structure is provided on the longitudinal end face of the cathode-anode unit,

wherein the electrically conductive structure comprises one or more connection ports for the one or more tabs,

wherein the one or more connection ports are in contact with the one or more tabs.

Example Ex67: The aerosol-generating device according to Ex66, wherein the electrically conductive structure bridges a distance in a longitudinal direction in between the cathode-anode unit and a terminal of the battery.

Example Ex68: The aerosol-generating device according to any one of examples Ex66 to Ex67, wherein the electrically conductive structure has a longitudinal extension of 2 millimeters to 8 millimeters.

Example Ex69: A method of operating an aerosol-generating device, comprising the steps of: detecting whether aerosol-delivery is requested by a consumer, delivering power from a battery to an aerosol-generating means via at least two tabs in the battery, wherein the tabs are arranged in parallel in an electrical circuit of which the battery forms part.

Example Ex70: The method according to example Ex69, wherein the step of detecting whether an aerosol-delivery is requested by a consumer, comprises detecting whether the consumer applies lower than ambient pressure on a mouthpiece of the aerosol-generating device.

Example Ex71: The method according to any one of examples Ex69 to Ex70, wherein the step of delivering power from the battery to the aerosol-generating means via the at least two tabs in the battery, comprises drawing current from the battery only when a heating temperature drops below a threshold level.

Example Ex72: The method according to any one of examples Ex69 to E71, wherein the discharge current is a pulsing current having at least one on-cycle and at least one off-cycle.

Example Ex73: The method according to example Ex72, wherein at least one of the on-cycle and the off-cycle has a duration of between 0.01 seconds and 3 seconds, preferably of between 0.1 seconds and 2 seconds, in particular of about 0.3 seconds.

Example Ex74: The method according to any one of examples Ex72 to Ex73, wherein the on-cycle and the off-cycle have substantially the same duration.

Example Ex75: The method according to any one of examples Ex71 to E73, wherein the discharge current has a peak current of in between 2 ampere and 5 ampere, preferably of between 2.5 ampere and 4 ampere, in particular of about 3.15 ampere.

Example Ex76: Use of at least two tabs provided on a cathode or an anode in an aerosol-generating device to increase rate capability of a battery for intermittent heating.

Example Ex77: The use according to examples Ex76, wherein power is only drawn from of the battery when a temperature of a heating element drops below a threshold level.

Examples will now be further described with reference to the figures.

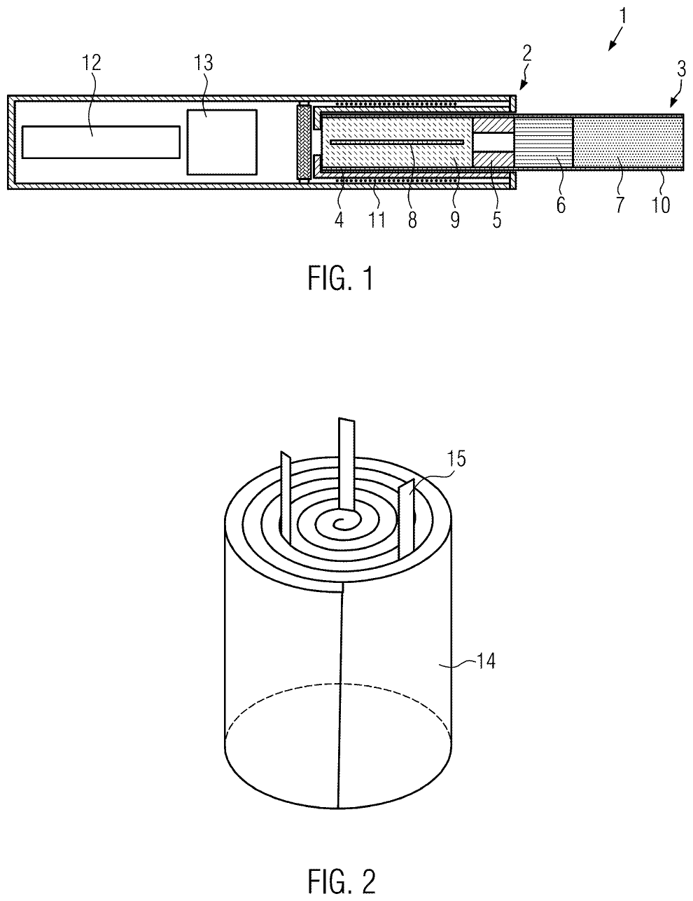

FIG. 1 shows a schematic cross-sectional view of an embodiment of an aerosol-generating system with an aerosol-generating device according to an embodiment of the invention.

FIG. 2 shows a schematic perspective view of a cathode-anode unit used in a first embodiment the aerosol-generating device according to FIG. 1;

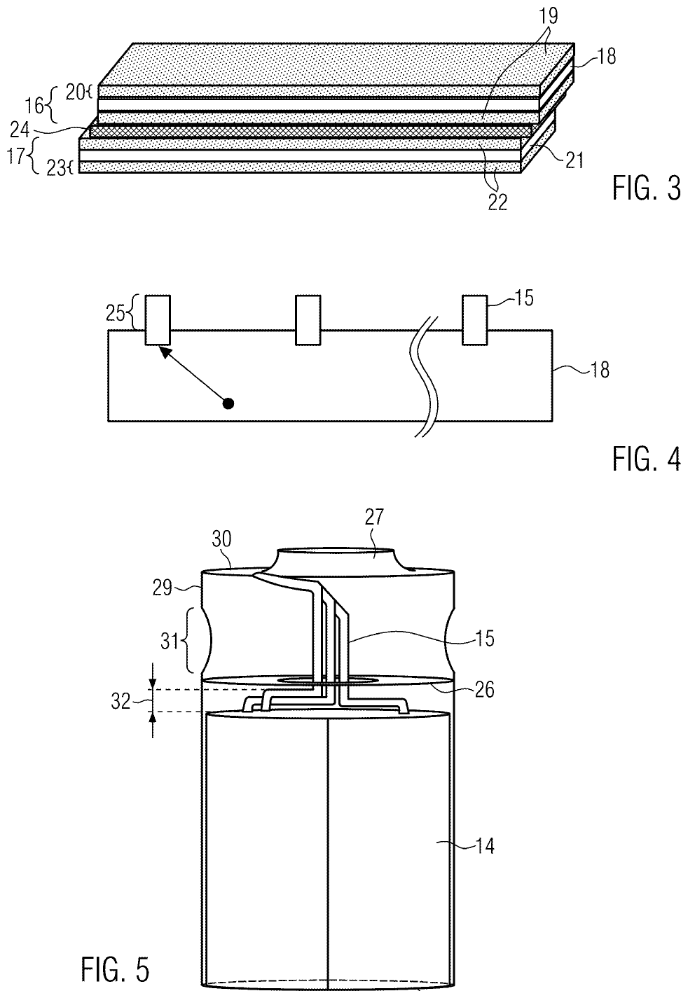

FIG. 3 shows a schematic partial perspective view of the cathode and anode of the cathode-anode unit according to FIG. 2 in an unrolled state;

FIG. 4 shows a schematic top view of an unrolled cathode current collector having multiple tabs, which may be used in the cathode-anode unit according to FIG. 2 and FIG. 3;

FIG. 5 shows a schematic perspective view of a battery for a second embodiment of the aerosol-generating system according to FIG. 1;

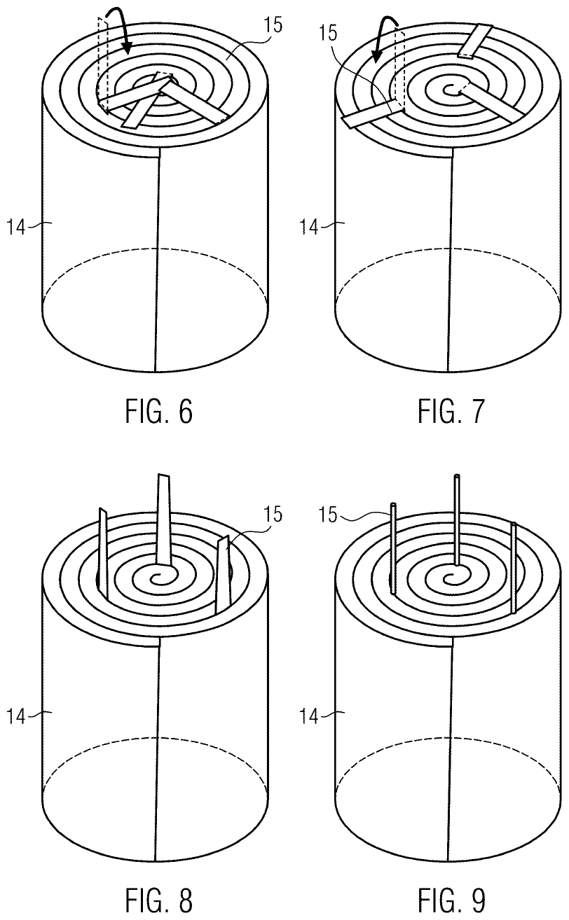

FIG. 6 shows a schematic perspective view of the cathode-anode unit used in a third embodiment of the aerosol-generating device according to FIG. 1;

FIG. 7 shows a schematic perspective view of the cathode-anode unit used in a fourth embodiment of the aerosol-generating device according to FIG. 1;

FIG. 8 shows a schematic perspective view of the cathode-anode unit used in a fifth embodiment of the aerosol-generating device according to FIG. 1;

FIG. 9 shows a schematic perspective view of the cathode-anode unit used in a sixth embodiment of the aerosol-generating device according to FIG. 1;

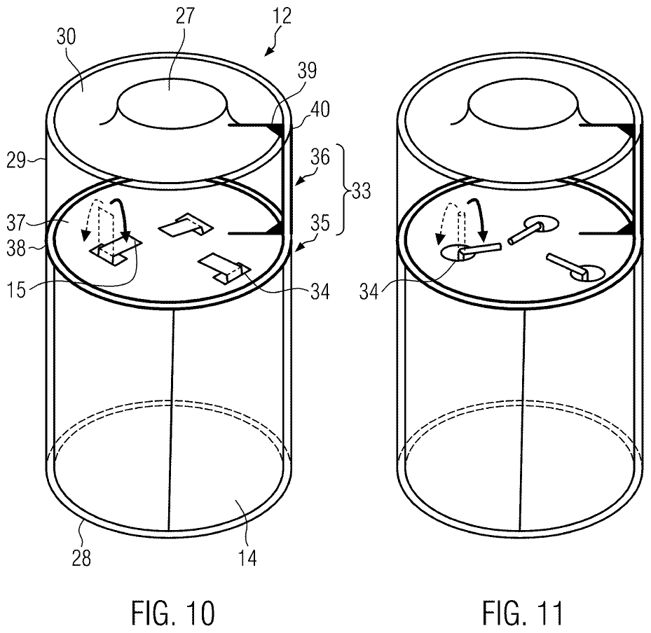

FIG. 10 shows a schematic perspective view of a battery for a seventh embodiment of the aerosol-generating device according to FIG. 1;

FIG. 11 shows a schematic perspective view of a battery for an eighth embodiment of the aerosol-generating device according to FIG. 1.

FIG. 1 schematically shows an embodiment of an aerosol-generating system 1. The system 1 comprises an aerosol-generating device 2 according to an embodiment of the invention as well as an aerosol-generating article 3 for use with the aerosol-generating device 2. The aerosol-generating article 3 comprises an aerosol-forming substrate 9 to be heated to form an inhalable aerosol.

The aerosol-generating article 3 is a rod-shaped consumable comprising four elements sequentially arranged in coaxial alignment: an aerosol-forming rod segment 4, a support element 5 having a central air passage, an aerosol-cooling element 6 and a mouthpiece element 7 comprising a filter. The aerosol-forming rod segment 4 is arranged at a distal end of the article 3 and comprises a strip-shaped susceptor 8 and the aerosol-forming substrate 9 to be heated. The mouthpiece element 7 is arranged at a proximal end of the article 3 allowing a consumer to puff thereon. The support element 5 and the aerosol-cooling element 6 are arranged in between. Each of the four elements is a substantially cylindrical element, all of them having substantially the same diameter. The four elements are circumscribed by an outer wrapper 10 such as to keep the four elements together and to maintain the desired circular cross-sectional shape of the rod-like article 3. The wrapper 10 preferably is made of paper.

The aerosol-generating device 2 comprises a cylindrical receiving cavity defined within a proximal portion 1 of the device 2 for receiving a least a distal portion of the article 3 therein. The device 2 further comprises a heating element 11 including an inductor for generating an alternating high-frequency magnetic field. In the present embodiment, the inductor is a helical coil circumferentially surrounding the cylindrical receiving cavity. In alternative embodiments, the heating element may be an electrical resistance heating means. The coil is arranged such that the susceptor 8 of the aerosol-generating article 3 is exposed to the alternating magnetic field upon engaging the article 3 with the device 2. Thus, when activating the heating element 11, the susceptor 8 heats up due to eddy currents and hysteresis losses that are induced by the alternating magnetic field within the susceptor 8, depending on its magnetic and electric material properties. The susceptor 8 is heated until reaching an operating temperature sufficient to vaporize the aerosol-forming substrate 9 surrounding the susceptor 8 within the article 3. Within a distal portion, the aerosol-generating device 2 further comprises a battery 12 and power supply electronics 13 for powering and controlling the heating process.

In use of the aerosol-generating system 1, when a consumer takes a puff at the mouthpiece element 7 of the article 3, air is drawn into the receiving cavity at the rim of the cavity. The air flow further extends towards the distal end of the cavity through a passage which is formed between the inner surface of the cylindrical cavity and the outer surface of the article 3. At the distal end of the cavity, the air flow enters the aerosol-generating article 3 through the substrate element 4 and further passes through the support element 5, the aerosol cooling element 6 and the mouthpiece element 7, where it finally exits the article 3. In the substrate element 4, vaporized material from the aerosol-forming substrate 9 is entrained into the air flow. Subsequently, when passing through the support element 5, the cooling element 6 and the mouthpiece element 7, the air flow including the vaporized material cools down such as to form an inhalable aerosol escaping the article 3 through the mouthpiece element 7.

In a first embodiment of the aerosol-generating device 2, the battery 12 comprises a cathode-anode unit 14 as shown in FIG. 2. The cathode-anode unit 14 is shown in an upright direction with the longitudinal axis extending in the vertical direction. The cathode-anode unit 14 has the form of a jellyroll. The cathode-anode unit 14 comprises multiple tabs 15. The multiple tabs 15 extend from the upper longitudinal end face of the cathode-anode unit 14.

Although three tabs are shown in FIG. 2, any number of tabs, but at least two, may be provided on the upper longitudinal end face of the cathode-anode unit 14. Preferably, the number of tabs may be two or three.

Although not shown in FIG. 2, one or more tabs are provided on the opposite, bottom longitudinal end-face of the cathode-anode unit 14. The number of tabs on both longitudinal end-faces of the cathode-anode unit 14 may be equal.

FIG. 3 shows the cathode-anode unit 14 according to FIG. 2 in an unrolled state. The cathode-anode unit 14 comprises two electrodes, namely a cathode 16 and an anode 17.

The cathode 16 is formed of multilayer sheet material. The multilayer sheet material of the cathode comprises a cathode current collector layer 18. The cathode current collector layer 18 is formed of a sheet material and comprises two opposing large surfaces. The cathode current collector layer 18 is coated on both surfaces with a cathode active material, such that a cathode active material layer 19 is formed on both surfaces of cathode current collector layer 18. In some examples, only one surface of cathode current collector layer 18 may be coated with the cathode active material.

Similar to the cathode 16, the anode 17 is formed of a multilayer sheet material. The multi-layer sheet material of the anode 17 comprises an anode current collector layer 21. The anode current collector layer 21 is formed of a sheet material and comprises two opposing large surfaces. The anode current collector layer 21 is coated on both surfaces with a cathode active material, such that an anode active material layer 22 is formed on both surfaces of anode current collector layer 21. In some examples, only one surface of the anode current collector layer 21 may be coated with the anode active material.

The cathode-anode unit 14 further comprises a separator 24. The separator 24 is formed of a sheet material. The separator is provided in between the cathode and the anode.

An example of the cathode current collector layer 18 is shown in FIG. 4 in top view. The vertical extension of the cathode current collector layer 18 as shown in FIG. 4 corresponds to the height of the cathode-anode unit 14 shown in FIG. 2. The horizontal extension of the cathode current collector layer 18 corresponds to the length of the cathode current collector layer 18 and is perpendicular to the vertical extension.

The anode current collector layer 21 may be formed with a similar or equal structure as the cathode current collector layer 18.

The multiple tabs 15 of the cathode-anode unit 14 as shown in FIG. 2 are provided on an edge of the cathode current collector layer 18 in a distance to each other. The distance is the extension in between the multiple tabs 15 with respect to the horizontal extension of the cathode current collector layer 18 in the unrolled state.

The multiple tabs 15 are provided on the edge, such that the multiple tabs 15 extend from the edge of the current collector layer 18 with a tab extending height 25.

An electron is schematically indicated in FIG. 4 as a black bullet point. The electron is one of a large number of electrons forming part of the cathode current collector layer 18. As the length of the current collector layer 18 is long, electrons need to travel a long distance when a single tab design is used. In contrast, when multiple tabs are provided, the travel distance is shorter and thus, battery rate capability is increased. The use of multiple tabs enables the battery 12 to generate a considerable amount of energy in a short time with little polarization even at high current loads.

As further shown in FIG. 4, each of the multiple tabs 15 has a rectangular shape.

In a second embodiment of the aerosol-generating device 2, the battery 12 comprises a tab attachment design as shown in FIG. 5. The battery 12 comprises the cathode-anode unit 14 according to FIG. 2, an isolator structure 26 and a housing with two terminals 27, 28 for connecting an electrical circuitry of the aerosol-generating device 2.

The upper terminal 27 is connected to the cathode to provide a positive terminal (+) and the bottom terminal 28 is connected to the anode to provide a negative terminal (−). The battery 12 has a cylindrical shape. Alternatively, the polarity of the terminals 27, 28 may be reversed; the battery 12 may have a cylindrical shape; both terminals 27, 28 may be provided on the same longitudinal end face of the battery; or the battery 12 may have a form and an arrangement of terminals similar to a known “9V block battery”.

The housing comprises a shell 29 and a cap 30 for closing the shell 29.

The shell 29 comprises a shell side wall, an upper shell opening for receiving the cathode-anode unit 14 during manufacturing and a lower shell end wall. The shell side wall may be in form of a cylindrical-shaped portion that extends in the longitudinal direction and provides a cavity for the cathode-anode unit 14. The shell end wall forms a bottom of the shell 29.

Both, the shell end wall and shell side wall are made of a conductive material, such as aluminum. The shell end wall and the shell side wall are electrically connected, such that they provide the same electrical potential. The shell end wall serves as the negative terminal (−).

The cap 30 has a round shape with an elevation in the middle that serves as the positive terminal (+). The cap 30 closes the shell opening. A second isolator structure (not shown) is provided that isolates the cap 30 from the shell 29. The second isolator structure may be provided on the cap 30 or the shell 29.

The shell 29 further comprises a neck portion 31 to hold the cathode-anode unit 14 in longitudinal direction in position. The neck portion 31 forms part of the cylindrical portion of the shell 29. The neck portion 31 is located above the upper longitudinal end face of the cathode-anode unit 14 and corresponds to a taper on the cylindrical portion of the shell 29.

In between the neck portion 31 and the cathode-anode unit 14, the isolator structure 26 is provided that isolates the multiple tabs 15 extending from the upper longitudinal end face of the cathode-anode unit 14 from the shell 29. As shown, the isolator structure 26 comprises a center hole for receiving the multiple tabs 15.

The multiple tabs 15 are attached to the cap 30. Preferably, the multiple tabs 15 are welded or soldered to the cap 30. As shown in FIG. 5 and FIG. 6, the multiple tabs 15 are folded inwardly towards the center of the battery 12 before they pass through the center hole of the isolator structure 26 to reach the cap 30, such that a stack of overlapping tabs is build up that extends in the longitudinal direction.

Because the size of the battery 12 used in the handheld aerosol-generating device 2 is limited, space needed by the overlapping tabs reduces the space available for the cathode-anode unit 14, and thus reduces energy capacity of the battery 12.

In embodiments of the aerosol-generating device 2 with cathode-anode units or batteries according to FIGS. 7 to 11, the overlapping space 32 caused by the use of the multiple tabs 15 may be reduced.

In fourth embodiment of the aerosol-generating device 2, the battery 12 comprises a cathode-anode unit 14 as shown in FIG. 7. According to the fourth embodiment, the multiple tabs 15 are folded outwardly. Thus, the overlapping space 32 caused by the multiple tabs 15 after folding may be reduced.

In fifth and sixth embodiment of the aerosol-generating device 2, the battery 12 comprises a cathode-anode unit 14 as shown in FIG. 8 and FIG. 9.

In contrast to the cathode-anode unit 14 shown in FIG. 2, the multiple tabs 15 according to FIG. 8 have a trapezoidal shape. The width of the multiple tabs 15 decreases with increasing distance to the longitudinal end face of the cathode-anode unit 14. Thus, the overlapping space 104 caused by the multiple tabs 15 after folding is reduced.

In contrast to the cathode-anode unit 14 shown in FIG. 2, the multiple tabs 15 according to FIG. 9 have a needle shape. Thus, the overlapping space 104 caused by the multiple tabs 15 after folding is reduced.

With reference to FIG. 5, an embodiment of the method of manufacturing the battery 12 for the aerosol-generating device 2 may comprise one or more of the following steps:

First, the cathode-anode unit 14 is provided. The cathode-anode unit 14 comprises three tabs 15 extending from the upper longitudinal end-face of the cathode-anode unit 14.

Second, the cathode-anode unit 14 is arranged in the shell 29. The cathode-anode unit 14 may be arranged, such as to abut the shell end wall.

Third, the three tabs 15 extending from bottom end-face of the cathode-anode unit 14 are attached to the bottom shell end wall. Preferably, the three tabs extending from the bottom end-face of the cathode-anode unit 14 are attached by welding the three tabs 15 to the bottom shell end wall. For example, a welding needle is passed through the center of the cathode-anode unit 14 to weld the three tabs 15 on the shell end wall.

Fourth, the shell 29 at least partially filled with an electrolyte.

Fifth, the isolator structure 26 is arranged above the cathode-anode unit 14, such that the three tabs 15 pass through the center hole of the isolator structure 26. The fifth step further comprises folding the three tabs 15 according to one of the techniques discussed regarding FIG. 6 and FIG. 7.

Sixth, the three tabs 15 are attached to the cap 30 by welding or soldering.

Usually, the three tabs 15 are sufficiently long to facilitate the attaching. For example, the tab extending height 25 for a battery with a 11390 design may be in the range of between 14 millimeters to 16 millimeters.

In a seventh and eight embodiment of the aerosol-generating device 2, the battery 12 comprises a tab attachment design as shown in FIG. 10 and FIG. 11. As far as the battery 12 comprises the same or similar features as the battery 12 according to FIG. 4, the same reference signs are used.

Instead of attaching the multiple tabs 15 directly at the cap 30, the battery 12 according to FIG. 10 and FIG. 11 comprises an electrically conductive structure 33 having connection ports 34 for the multiple tabs 15. Basically, the electrically conductive structure 33 allows to attach the multiple tabs 15 to the connection ports 34 instead of the cap 30, thereby reducing their length and thus space consumption. The electrically conductive structure 33 may also reduce folding and thus the instance of a broken tab. Finally, the electrically conductive structure 33 allows the neck portion 31 to be removed.

The electrically conductive structure 33 comprises a platform 35 and a connector 36. The platform 35 has a periphery, which conforms to an inner rim of the shell 29. The platform 35 is arranged on the longitudinal end face of the cathode-anode unit 14. The platform 35 is made of a conductive structure 37 and a non-conductive structure 38. The conductive structure 37 comprises connection ports 34 in form of multiple holes for receiving the multiple tabs 15. The number of connection ports 34 is equal to the number of tabs 15. The openings are provided as holes. In other examples, slots may be provided.

As shown in FIG. 10, slots are provided when rectangular-shaped tabs are used. Similarly, slots may be provided when trapezoidal-shaped tabs are used.

As shown in FIG. 11, holes are provided when needle-shaped tabs are used. During manufacturing, the multiple tabs 15 are passed through the openings, folded inwardly or outwardly, and are then welded or soldered to the conductive structure 37. Due to the mechanical strength of needles, the multiple tabs 15 can be easily pass through the openings without cracking.

The non-conductive structure 38 is formed on the periphery of the conductive structure 37, such that the conductive structure 37 is electrically isolated from the shell 29. The platform replaces the isolator structure 26 shown in FIG. 4.

The platform 35 is attached to the shell 29, such that the cathode-anode unit 14 is fixed to a longitudinally position with respect to the shell 29. In particular, the non-conductive structure 26 is sealed to the shell side wall. This allows the cathode-anode unit 14 to be held in position in the longitudinal direction and neglects the need for the neck portion 31. This allows the space for cathode-anode unit 14 and thus volumetric energy density of the battery 12 to be increased.

The connector 36 is provided in between the platform 35 and the cap 30. The connector 36 bridges a distance in a longitudinal direction in between the cathode-anode unit 14 and the cap 30. The connector 36 comprises a conductive structure 39 to electrically connect the multiple tabs 15 to the cap 30 and a non-conductive structure 40 for isolating the conductive structure 39 from the shell 29.

The conductive structure 39 of the connector 36 has a “U”-shape. In particular, the connector has three connector sections, wherein each a first connector section and a second connector section are connected to a third connector section at a 90 degree angle. The first connector section and the second connector section extend in the same transversal direction. The first connector section is attached to the cap 30. The second connector section is attached to the conductive structure 37 of the platform 35.

With reference to manufacturing method of the battery 12 according to FIG. 4, the method of manufacturing the battery 12 according to FIG. 10 and FIG. 11 may also comprise the first to fourth steps.

Instead of the fifth step of arranging the isolator structure 26 and the sixth step of attaching the multiple tabs 15 to the cap 30, the method of manufacturing the battery 12 according to FIG. 10 and FIG. 11 comprises one or more of the following steps:

Fifth, the electrically conductive structure 33 is arranged on the longitudinal end face of the cathode-anode unit 14 such that the three tabs 15 are in contact with the three connection ports 34 of the electrically conductive structure 33. The fifth step further comprise one more of the following steps:

Each of the three tabs 15 are passed through a corresponding hole of three holes that form the three connection ports 34.

The electrically conductive structure 33 is attached to the shell 29. Preferably, the electrically conductive structure 33 is sealed to the shell side wall.

The three tabs 15 are folded inwardly or outwardly, and are attached to the electrically conductive structure 33.

Sixth, the electrically conductive structure 33 is attached to the cap 30. Preferably, the electrically conductive structure 33 is welded or soldered to the cap 30.

1.-15. (canceled)

16. An aerosol-generating device, comprising:
a battery configured to supply power for heating, the battery comprising a cathode-anode unit,
wherein the cathode-anode unit comprises a cathode and an anode, the cathode and the anode being wound around a longitudinal direction to form a plurality of windings,
wherein at least one of the cathode and the anode is provided with at least two tabs,
wherein the at least two tabs are arranged in a distance from each other, and
wherein a number of the at least two tabs is less than a number of the windings.

17. The aerosol-generating device according to claim 16, wherein the at least two tabs are arranged on the cathode or the anode so that only one tab is included per at least 2 windings, at least 5 windings, or at least 15 windings.

18. The aerosol-generating device according to claim 16, wherein the cathode is formed of a multilayer sheet material, comprising:
a cathode current collector layer, and
a cathode active material layer,
wherein the cathode active material layer is a coating on one side of the cathode current collector, and
wherein the coating forming the cathode active material layer has a thickness of 30 micrometers to 60 micrometers.

19. The aerosol-generating device according to claim 18, wherein the coating forming the cathode active material layer has a thickness of 40 micrometers to 50 micrometers.

20. The aerosol-generating device according to claim 18, wherein at least one of the at least two tabs is attached to the cathode current collector, being ultrasonically or resistively welded.

21. The aerosol-generating device according to claim 16, wherein the at least two tabs are extending from the cathode or the anode towards a periphery of the battery.

22. The aerosol-generating device according to claim 16, wherein the battery further comprises an electrically conductive structure having connection ports for the at least two tabs.

23. The aerosol-generating device according to claim 22, wherein the electrically conductive structure bridges a distance in a longitudinal direction in between the cathode or the anode and a terminal of the battery.

24. The aerosol-generating device according to claim 22, wherein the connection ports of the electrically conductive structure are openings configured to receive the at least two tabs, the openings being holes or slots.

25. A method of operating an aerosol-generating device, comprising the steps of:
detecting whether aerosol-delivery is requested by a consumer; and
delivering power from a battery to an aerosol-generating means via at least two tabs in the battery, wherein the battery comprises a cathode and an anode, the cathode and the anode being wound around a longitudinal direction to form a plurality of windings,
wherein the at least two tabs are arranged in parallel in an electrical circuit of which the battery forms part, and
wherein a number of the at least two tabs is less than a number of the windings.

26. The method according to claim 25, wherein the step of delivering power comprises drawing current from the battery only when a heating temperature drops below a threshold level.

27. The method according to claim 26, wherein a discharge current is a pulsing current having at least one on-cycle and at least one off-cycle.

28. The method according to claim 27, wherein at least one of the on-cycle and the off-cycle has a duration of between 0.01 second and 3 seconds.

29. The method according to claim 27, wherein at least one of the on-cycle and the off-cycle has a duration of between 0.1 second and 2 seconds.

30. The method according to claim 27, wherein at least one of the on-cycle and the off-cycle has a duration of about 0.3 second.

31. The method according to claim 26, wherein a discharge current has a peak current of in between 2 ampere and 5 ampere.

32. The method according to claim 26, wherein a discharge current has a peak current of in between 2.5 ampere and 4 ampere.

33. The method according to claim 26, wherein a discharge current has a peak current of about 3.15 ampere.
